(19) United States
(12) Patent Application Publication
(10) Pub. No.: US 2019/0041561 A1
(43) Pub. Date: Feb. 7, 2019

(54) REFLECTIVE LAMINATE, METHOD FOR PRODUCING SAME, BANDPASS FILTER, AND WAVELENGTH SELECTIVE SENSOR

(71) Applicant: FUJIFILM Corporation, Tokyo (JP)

(72) Inventor: Ryoji GOTO, Kanagawa (JP)

(73) Assignee: FUJIFILM Corporation, Tokyo (JP)

(21) Appl. No.: 16/143,494

(22) Filed: Sep. 27, 2018

Related U.S. Application Data
(63) Continuation of application No. PCT/JP2017/010980, filed on Mar. 17, 2017.

(30) Foreign Application Priority Data
Mar. 29, 2016 (JP) 2016-065472

(51) Int. Cl. G02B 5/26; G02B 5/22; B32B 7/02; G02B 5/28; G02B 1/12

(52) U.S. Cl. CPC G02B 5/26; G02B 5/22; G02B 1/12; G02B 5/281; B32B 7/02

(57) ABSTRACT

The present invention provides a reflective laminate capable of efficiently reflecting light in a wide wavelength range, a method for producing the reflective laminate, a bandpass filter, and a wavelength selective sensor. The reflective laminate according to the present invention is a reflective laminate including at least one first reflective layer that reflects dextrorotatory circularly polarized light and at least one second reflective layer that reflects levorotatory circularly polarized light, in which the selective reflection wavelengths of the first reflective layer and the second reflective layer are each 600 nm or more, and each of the first reflective layer and the second reflective layer is a layer obtained by immobilizing a dichroic dye having an absorption maximum wavelength on a longer wavelength side than 400 nm in a cholesteric alignment state.

### CROSS-REFERENCE TO RELATED APPLICATIONS

This application is a Continuation of PCT International Application No. PCT/JP2017/010980 filed on Mar. 17, 2017, which claims priority under 35 U.S.C. § 119(a) to Japanese Patent Application No. 2016-065472 filed on Mar. 29, 2016. The above application is hereby expressly incorporated by reference, in its entirety, into the present application.

### BACKGROUND OF THE INVENTION

### 1. Field of the Invention

The present invention relates to a reflective laminate and a method for producing the same, a bandpass filter, and a wavelength selective sensor.

### 2. Description of the Related Art

The bandpass filter can transmit light in a predetermined wavelength range and is therefore applied to various optical sensors. By using such a bandpass filter, for example, only the light reflected by an object, among the light emitted from a light source included in an optical sensor, can be selectively transmitted and received by various kinds of elements.

For example, in JP2003-344634A, it has been proposed to use a reflective layer utilizing selective reflection characteristics of a cholesteric liquid crystalline phase as a bandpass filter.

### SUMMARY OF THE INVENTION

On the other hand, improvement of the performance of the reflective layer has recently been required. Specifically, a reflective layer capable of efficiently reflecting light in a wide wavelength range has been required.

Generally, in the case where a reflective layer utilizing selective reflection characteristics of a cholesteric liquid crystalline phase is used, light in a wide wavelength range is reflected by laminating a plurality of reflective layers having different selective reflection wavelengths. However, in the case where the reflective layer is capable of efficiently reflecting light in a wide wavelength range, it is possible to reduce the number of laminated layers of the reflective layer, which leads to thinning.

The present inventors have studied the characteristics of the reflective layer utilizing the selective reflection characteristics of the known cholesteric liquid crystalline phase as described in JP2003-344634A and found that the reflection wavelength range of the reflective layer is not always wide and reflection characteristics thereof are not sufficient, and therefore further improvement in the reflective layer is necessary.

In view of the above circumstances, an object of the present invention is to provide a reflective laminate capable of efficiently reflecting light in a wide wavelength range.

Another object of the present invention is to provide a method for producing the reflective laminate, a bandpass filter, and a wavelength selective sensor.

As a result of extensive studies on the foregoing objects, the present inventors have found that the foregoing objects can be achieved by using a layer obtained by immobilizing a dichroic dye in a cholesteric alignment state. The present invention has been completed based on these findings.

That is, the present inventors have found that the foregoing objects can be achieved by the following configuration.

(1) A reflective laminate comprising: at least one first reflective layer that reflects dextrorotatory circularly polarized light; and at least one second reflective layer that reflects levorotatory circularly polarized light,

in which the selective reflection wavelengths of the first reflective layer and the second reflective layer are each 600 nm or more, and

each of the first reflective layer and the second reflective layer is a layer obtained by immobilizing a dichroic dye having an absorption maximum wavelength on a longer wavelength side than 400 nm in a cholesteric alignment state.

(2) The reflective laminate according to (1), in which the content of the dichroic dye in at least one of the first reflective layer or the second reflective layer is 45% by mass or more with respect to the total mass of the layer.

(3) The reflective laminate according to (1) or (2), in which the dichroic dye has liquid crystallinity.

(4) The reflective laminate according to any one of (1) to (3), in which a total value of a film thickness of the first reflective layer and a film thickness of the second reflective layer is 10 μm or less.

(5) The reflective laminate according to any one of (1) to (4), further comprising an ultraviolet absorbing layer.

(6) The reflective laminate according to (5), in which the ultraviolet absorbing layer has absorption in a visible light range.

(7) The reflective laminate according to any one of (1) to (6), further comprising a light absorbing layer that absorbs at least one of visible light or near infrared light.

(8) A bandpass filter comprising the reflective laminate according to any one of (1) to (7).

(9) A wavelength selective sensor comprising the bandpass filter according to (8).

(10) The method for producing the reflective laminate according to any one of (1) to (7), comprising:

a step of bringing a composition containing a dichroic dye having a polymerizable group, a dextrorotatory chiral agent, and a polymerization initiator into a cholesteric alignment state and then immobilizing the composition in the cholesteric alignment state to form a first reflective layer; and

a step of bringing a composition containing a dichroic dye having a polymerizable group, a levorotatory chiral agent, and a polymerization initiator into a cholesteric alignment state and then immobilizing the composition in the cholesteric alignment state to form a second reflective layer.

(11) The method for producing the reflective laminate according to (10), in which the content of the dichroic dye having a polymerizable group is 45% by mass or more with respect to the total solid content in the composition.

(12) The method for producing the reflective laminate according to (10) or (11), in which the composition includes a liquid crystal compound which has a polymerizable group and has no absorption maximum wavelength on a longer wavelength side than 400 nm.

According to the present invention, it is possible to provide a reflective laminate capable of efficiently reflecting light in a wide wavelength range.

Further, according to the present invention, it is possible to provide a method for producing the reflective laminate, a bandpass filter, and a wavelength selective sensor.

### BRIEF DESCRIPTION OF THE DRAWINGS

FIG. 1 is a cross-sectional view of a first embodiment of a reflective laminate of the present invention.

FIG. 2 is a cross-sectional view of a second embodiment of the reflective laminate of the present invention.

FIG. 3 is a transmission spectrum of a reflective layer (FR1).

FIG. 4 is a transmission spectrum of a reflective layer (FR2).

FIG. 5 is a transmission spectrum of a reflective layer (FL1).

FIG. 6 is a transmission spectrum of a reflective layer (CFR1).

FIG. 7 is a transmission spectrum of a reflective layer (CFL1).

FIG. 8 is a transmission spectrum of a reflective laminate (F1).

### DESCRIPTION OF THE PREFERRED EMBODIMENTS

Hereinafter, suitable aspects of the present invention will be described.

Descriptions of the constituent elements described below may be made based on representative embodiments of the present invention, but the present invention is not limited to such embodiments.

In the present specification, the numerical range expressed by using “to” means a range including numerical values described before and after “to” as a lower limit value and an upper limit value, respectively.

### First Embodiment

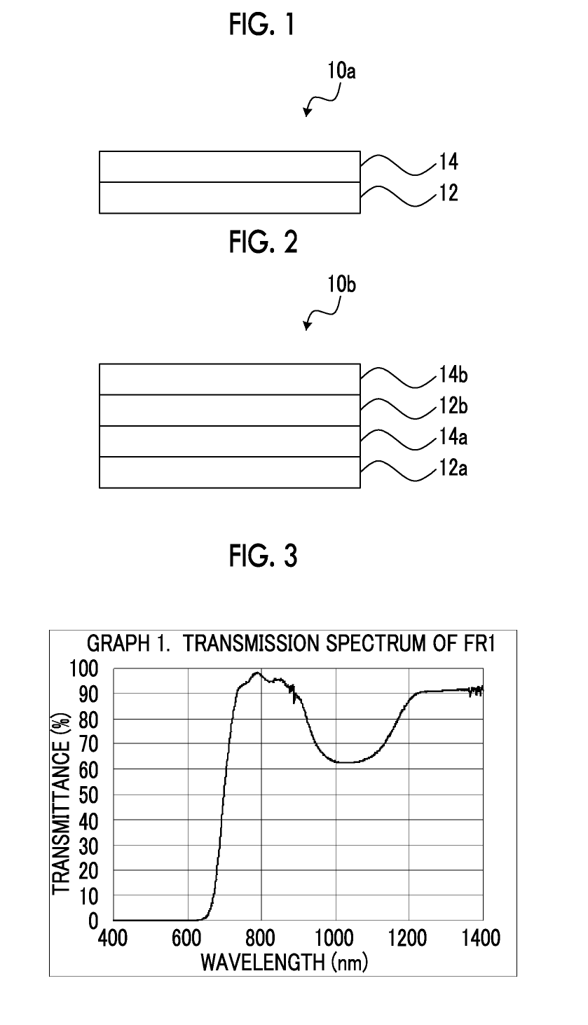

FIG. 1 shows a cross-sectional view of a first embodiment of a reflective laminate of the present invention.

As shown in FIG. 1, a reflective laminate 10a includes a first reflective layer 12 that reflects dextrorotatory circularly polarized light and a second reflective layer 14 that reflects levorotatory circularly polarized light.

The first reflective layer 12 and the second reflective layer 14 have about the same helical pitches and show turning properties in directions opposite to each other. Therefore, the selective reflection wavelength of the first reflective layer 12 is equal to the selective reflection wavelength of the second reflective layer 14. Accordingly, the reflective laminate 10a can reflect both dextrorotatory circularly polarized light and levorotatory circularly polarized light of about the same wavelengths.

In addition, as will be described later in detail, the first reflective layer 12 and the second reflective layer 14 are layers obtained by immobilizing a dichroic dye in a cholesteric alignment state, and reflect light in a predetermined wavelength range. In addition, the first reflective layer 12 and the second reflective layer 14 absorb light in a visible light range due to the characteristics of the dichroic dye. Therefore, for example, in the case where light having a predetermined wavelength in the infrared light range is reflected by the first reflective layer 12 and the second reflective layer 14, and in the case where light is incident on the reflective laminate 10a, light in the visible light range is absorbed and light having a predetermined wavelength in the infrared light range is reflected, whereby only light in a specific wavelength region can transmit through the reflective laminate 10a. That is, the reflective laminate 10a can be used as a selective wavelength transmission filter (bandpass filter) having a transmission band in a specific wavelength region.

The selective reflection wavelength of the first reflective layer 12 is intended to refer to a wavelength (maximum reflection wavelength) exhibiting a peak at which the reflectance is the highest in a reflectance curve (reflectance graph) of wavelength (horizontal axis)-reflectance (vertical axis) of the first reflective layer 12.

The selective reflection wavelength of the second reflective layer 14 is intended to refer to a wavelength (maximum reflection wavelength) exhibiting a peak at which the reflectance is the highest in a reflectance curve (reflectance graph) of wavelength (horizontal axis)-reflectance (vertical axis) of the second reflective layer 14.

Absolute reflectance spectrum measurement systems V-670 and ARMN-735 (manufactured by JASCO Corporation), and the like are used as a method of measuring the selective reflection wavelength.

In the above description, the selective reflection wavelength is obtained by using the reflectance, but the selective reflection wavelength may be obtained from the transmittance. The transmittance can be considered to be a value obtained by subtracting the reflectance, the absorbance, and the scattering rate from the light incident on a sample. In the present specification, the selective reflection wavelength can be evaluated by measuring the transmittance in the wavelength region where there is no influence of absorption of the sample with less scattering. That is, the selective reflection wavelength of the reflective layer (the first reflective layer 12 and the second reflective layer 14) can also be obtained as a wavelength (maximum reflection wavelength) exhibiting a peak at which the transmittance is the lowest in the wavelength region where there is no influence of absorption, in the transmittance curve of wavelength (horizontal axis)-transmittance (vertical axis) of the reflective layer.

As a method for measuring the transmittance, a UV-Vis-NIR spectrophotometer UV-3100PC (manufactured by Shimadzu Corporation) or the like is used.

Further, as described above, the selective reflection wavelength of the first reflective layer 12 is equal to the selective reflection wavelength of the second reflective layer 14. The fact that the selective reflection wavelengths of the two reflective layers are “equal to each other” does not mean that they are strictly equal to each other, and an error in a range in which there is no optical influence is allowed. In the present specification, selective reflection wavelengths of two reflective layers are “equal to each other” is intended to mean that the difference between the selective reflection wavelengths of the two reflective layers is 20 nm or less, and this difference is preferably 15 nm or less and more preferably 10 nm or less.

By laminating two reflective layers having selective reflection wavelengths equal to each other and having different right and left turning properties, the transmission spectrum of the reflective laminate shows one strong peak at this selective reflection wavelength, which is preferable from the viewpoint of reflection performance.

In FIG. 1, an aspect in which the selective reflection wavelength of the first reflective layer 12 is equal to the selective reflection wavelength of the second reflective layer 14 will be described, but the selective reflection wavelengths of both may be different from each other.

The reflective laminate 10a has a transmission band through which light having a predetermined wavelength transmits.

The range of the transmission band is not particularly limited, and can be appropriately adjusted by changing the helical pitch in the first reflective layer and the second reflective layer, the number of laminated layers, and the like. The transmission band is preferably in the range of 750 to 1050 nm, and more preferably in the range of 820 to 880 nm or 910 to 970 nm.

As described above, the reflective laminate 10a can absorb light in the visible light range due to the characteristics of the dichroic dye. Examples of light in the visible light range absorbed by the reflective laminate 10a include light in a wavelength range of 400 to 700 nm.

The total value of the film thickness of the first reflective layer 12 and the film thickness of the second reflective layer 14 in the reflective laminate 10a is not particularly limited, but it is preferably 10 μm or less and more preferably 5 μm or less, from the viewpoint of thinning. The lower limit thereof is not particularly limited, but it is often 1 μm or more from the viewpoint of handleability.

The reflective laminate 10a shown in FIG. 1 has one each of the first reflective layer 12 and the second reflective layer 14, but the present invention is not limited to this aspect, and as will be described later, the reflective laminate may include a plurality of first reflective layers 12 and a plurality of second reflective layers 14.

Further, as will be described later, the reflective laminate 10a may include members other than the first reflective layer 12 and the second reflective layer 14.

Hereinafter, the first reflective layer and the second reflective layer included in the reflective laminate will be described in detail.

[First Reflective Layer and Second Reflective Layer]

The first reflective layer is a layer that reflects dextrorotatory circularly polarized light. As will be described later, the first reflective layer is a layer obtained by immobilizing a predetermined dichroic dye in a cholesteric alignment state (a layer obtained by immobilizing a cholesteric liquid crystalline phase of a dichroic dye). In other words, the first reflective layer is a layer containing a dichroic dye twist-aligned in the right rotation direction along the helical axis extending along the thickness direction.

The second reflective layer is a layer that reflects levorotatory circularly polarized light. As will be described later, the second reflective layer is a layer obtained by immobilizing a predetermined dichroic dye in a cholesteric alignment state (a layer obtained by immobilizing a cholesteric liquid crystalline phase of a dichroic dye). In other words, the second reflective layer is a layer containing a dichroic dye twist-aligned in the left rotation direction along the helical axis extending along the thickness direction.

The selective reflection wavelengths of the first reflective layer and the second reflective layer are each 600 nm or more. In particular, the selective reflection wavelengths of the first reflective layer and the second reflective layer are preferably in the range of 600 to 2000 nm and more preferably in the range of 600 to 800 nm or 950 to 1200 nm.

The definition of the selective reflection wavelength is as described above.

The film thickness of the first reflective layer and the second reflective layer is not particularly limited, but it is preferably 1 to 5 μm and more preferably 1 to 3 μm from the viewpoint of shortening the optical path length.

Each of the first reflective layer and the second reflective layer is a layer obtained by immobilizing a dichroic dye having an absorption maximum wavelength on a longer wavelength side than 400 nm, in a cholesteric alignment state. In the case of such a layer, due to the high refractive index anisotropy Δn of the dichroic dye, the reflection band of the reflective layer is broadened and the reflection efficiency is also improved.

As a suitable aspect of the first reflective layer and the second reflective layer, as will be described later, preferred is a layer obtained in such a manner that a composition containing a dichroic dye having a polymerizable group is applied, the dichroic dye in the applied composition is cholesteric-aligned, and then the composition is subjected to a curing treatment to immobilize the cholesteric alignment state.

(Dichroic Dye)

The first reflective layer and the second reflective layer contain at least a dichroic dye.

The dichroic dye refers to a coloring agent having a property that the absorbance in the long axis direction of the molecule is different from the absorbance in the minor axis direction.

In at least one of the first reflective layer or the second reflective layer, the content of the dichroic dye is preferably 45% by mass or more and more preferably 70% by mass or more with respect to the total mass of the layer. In the case where the content of the dichroic dye is within the above range, the reflection band of the reflective layer is further broadened and the reflection efficiency is further improved.

In at least one of the first reflective layer or the second reflective layer, it is preferred that the reflective layer is constituted only of a dichroic dye and a chiral agent.

The dichroic dye has an absorption maximum wavelength on a longer wavelength side than 400 nm. Among them, from the viewpoint of increasing the refractive index anisotropy Δn of the dichroic dye, the maximum absorption wavelength of the dichroic dye is preferably in the range of 450 to 700 nm and more preferably in the range of 500 to 700 nm.

As a method for measuring the absorption maximum wavelength of the dichroic dye, for example, a solution absorption spectrum measurement and a film absorption spectrum measurement using a UV-Vis absorption measurement apparatus UV-3100PC (manufactured by Shimadzu Corporation) can be mentioned.

It is preferred that the dichroic dye has liquid crystallinity. More specifically, it is preferred that the dichroic dye exhibits thermotropic liquid crystallinity, that is, it transits into a liquid crystalline phase by heat and exhibits liquid crystallinity. The dichroic dye preferably exhibits nematic liquid crystallinity at 30° C. to 200° C. (preferably 30° C. to 150° C.).

The refractive index anisotropy Δn of the dichroic dye is not particularly limited, but it is preferably 0.5 or more and more preferably 1.0 or more from the viewpoint that the effect of the present invention is superior. The upper limit thereof is not particularly limited, but it is often 2.0 or less.

As a method for measuring the refractive index anisotropy Δn, a method using a wedge-shaped liquid crystal cell described on page 202 of the Liquid Crystal Handbook (edited by Liquid Crystal Handbook Editing Committee, published by Maruzen Co., Ltd.) is generally used. In the case of a compound which is liable to crystallize, the refractive index anisotropy Δn can be estimated from the extrapolated value through the evaluation of a mixture with other liquid crystals. As a simple method of estimating Δn in the near infrared light range (for example, a wavelength region of wavelengths greater than 700 nm and 800 nm or less), for example, there is also a method of measuring a liquid crystal film of a dichroic dye in which a horizontal uniaxial alignment state (A-plate) is taken on a horizontally aligned cell or an alignment film the dye with an AxoScan (manufactured by Axometrics Inc.) and then converting the measured value into a film thickness.

The refractive index anisotropy Δn corresponds to a measured value at a wavelength of 800 nm at 35° C.

Examples of the dichroic dye include an acridine dye, an oxazine dye, a cyanine dye, a naphthalene dye, an azo dye, and an anthraquinone dye, among which an azo dye is preferred. Examples of the azo dye include a monoazo dye, a bisazo dye, a trisazo dye, a tetrakisazo dye, and a stilbene azo dye.

The dichroic dyes may be used alone or in combination of two or more thereof.

As will be described later in detail, the first reflective layer and the second reflective layer may be formed by using a dichroic dye having a polymerizable group (hereinafter, also referred to as “polymerizable dichroic dye”).

The type of the polymerizable group contained in the dichroic dye is not particularly limited and is preferably a functional group capable of an addition polymerization reaction, among which a polymerizable ethylenically unsaturated group or a cyclic polymerizable group is preferable. More specifically, the polymerizable group is preferably a (meth)acryloyl group, a vinyl group, a styryl group, an allyl group, an epoxy group, or an oxetane group, and more preferably a (meth)acryloyl group.

The first reflective layer and the second reflective layer may contain components other than the dichroic dye. For example, a liquid crystal compound and an alignment agent can be mentioned, and these components will be described later in detail.

[Method for Producing Reflective Layer]

A method for producing the first reflective layer and the second reflective layer is not particularly limited, and a known method can be adopted. Among them, a production method having Step 1 and Step 2 below is preferable from the viewpoint that the characteristics (for example, selective reflection wavelength) of the reflective layer can be easily controlled.

Step 1: a step of forming a coating film (composition layer) using a composition containing a dichroic dye, and subjecting the coating film to a heating treatment to bring the dichroic dye into a cholesteric alignment state (cholesteric liquid crystalline phase)

Step 2: a step of immobilizing the cholesteric alignment state

Hereinafter, each step will be described in detail.

[Step 1]

The composition used in Step 1 contains at least a dichroic dye. As the dichroic dye, a polymerizable dichroic dye may be used as described above.

If necessary, the composition used in Step 1 may contain components other than the dichroic dye.

(Chiral Agent)

The composition may contain a chiral agent.

A dextrorotatory chiral agent and a levorotatory chiral agent can be used as the chiral agent. Specifically, the first reflective layer preferably contains a dextrorotatory chiral agent, and the second reflective layer preferably contains a levorotatory chiral agent.

The type of the chiral agent is not particularly limited. The chiral agent may be liquid crystalline or non-liquid crystalline. The chiral agent may be selected from a variety of known chiral agents (for example, as described in Liquid Crystal Device Handbook, Chap. 3, Item 4-3, Chiral Agents for Twisted Nematic (TN) and Super Twisted Nematic (STN), p. 199, edited by the 142^{nd} Committee of the Japan Society for the Promotion of Science, 1989). The chiral agent generally contains an asymmetric carbon atom; however, an axial asymmetric compound or planar asymmetric compound not containing an asymmetric carbon atom may also be used as the chiral agent. Examples of the axial asymmetric compound or the planar asymmetric compound include binaphthyl, helicene, paracyclophane, and derivatives thereof. The chiral agent may have a polymerizable group.

The content of the chiral agent in the composition is not particularly limited, but it is preferably 0.5% to 30% by mass with respect to the total solid content of the composition. The chiral agent is preferably a compound having a strong twisting power in order that the compound could achieve twisted alignment of the desired helical pitch even though its amount used is small.

Examples of such a chiral agent having strong twisting power include the chiral agents described in, for example, JP2003-287623A, JP2002-302487A, JP2002-80478A, JP2002-80851A, and JP2014-034581A, and LC-756 manufactured by BASF Corporation.

(Liquid Crystal Compound)

The composition may contain a liquid crystal compound. This liquid crystal compound is a compound different from the dichroic dye.

The type of the liquid crystal compound is not particularly limited, and a known liquid crystal compound can be used. The liquid crystal compounds can be classified into rod type (rod-like liquid crystal compound) and disc type (discotic liquid crystal compound, disk-like liquid crystal compound) depending on the shape thereof. Further, the rod type and the disk type each have a low molecular weight type and a high molecular weight type. The high molecular weight generally refers to having a degree of polymerization of 100 or more (Polymer Physics-Phase Transition Dynamics, Masao Doi, page 2, Iwanami Shoten, 1992). Any liquid crystal compound can be used in the present invention. Two or more liquid crystal compounds may be used in combination.

The liquid crystal compound may have a polymerizable group. The type of the polymerizable group is not particularly limited, and examples thereof include the groups exemplified in the explanation of the polymerizable group contained in the polymerizable dichroic dye described above.

A suitable aspect of the liquid crystal compound may be, for example, a liquid crystal compound having a polymerizable group and having no absorption maximum wavelength on a longer wavelength side than 400 nm. By using this liquid crystal compound, improvement of stability of the liquid crystalline phase and improvement of curability by suppressing crystallization of the liquid crystal compound can be expected.

As a method for measuring the absorption maximum wavelength of the liquid crystal compound, for example, there are a solution absorption spectrum measurement and a film absorption spectrum measurement using a UV-Vis-NIR spectrophotometer UV-3100PC (manufactured by Shimadzu Corporation).

The content of the liquid crystal compound in the composition is not particularly limited, but it is preferably 1% to 50% by mass and more preferably 5% to 50% by mass, with respect to the total solid content of the composition.

(Polymerization Initiator)

The composition may contain a polymerization initiator.

The polymerization initiator is preferably a photopolymerization initiator capable of initiating a polymerization reaction upon irradiation with ultraviolet rays. Examples of the photopolymerization initiator include α-carbonyl compounds (as described in U.S. Pat. No. 2,367,661A and U.S. Pat. No. 2,367,670A), acyloin ethers (as described in U.S. Pat. No. 2,448,828A), α-hydrocarbon-substituted aromatic acyloin compounds (as described in U.S. Pat. No. 2,722,512A), polynuclear quinone compounds (as described in U.S. Pat. No. 3,046,127A and U.S. Pat. No. 2,951,758A), combinations of triarylimidazole dimer and p-aminophenyl ketone (as described in U.S. Pat. No. 3,549,367A), acridine and phenazine compounds (as described in JP1985-105667A (JP-S60-105667A) and U.S. Pat. No. 4,239,850A), and oxadiazole compounds (as described in U.S. Pat. No. 4,212,970A).

The content of the polymerization initiator in the composition is not particularly limited, but it is preferably 0.1% to 20% by mass and more preferably 1% to 8% by mass, with respect to the total solid content of the composition.

(Alignment Control Agent)

The composition may contain an alignment control agent. The inclusion of the alignment control agent in the composition makes it possible to achieve stable or rapid formation of cholesteric alignment.

Examples of the alignment control agent include fluorine-containing (meth)acrylate-based polymers, compounds represented by General Formulae (X1) to (X3) described in WO2011/162291A, and compounds described in paragraphs [0020] to [0031] of JP2013-47204A. The composition may contain two or more selected from these compounds. These compounds can reduce the tilt angle of the molecules of the liquid crystal compound (or dichroic dye having liquid crystallinity) at the air interface of the layer, or align the molecules substantially horizontally. In the present specification, the term “horizontal alignment” refers to that the long axis of the liquid crystal molecule is parallel to the layer surface, but does not require strict parallelism. In the present specification, the “horizontal alignment” means an alignment in which the tilt angle to the horizontal plane is less than 20°.

The alignment control agents may be used alone or in combination of two or more thereof.

The content of the alignment control agent in the composition is not particularly limited, but it is preferably 0.01% to 10% by mass, more preferably 0.01% to 5% by mass, and still more preferably 0.02% to 1% by mass, with respect to the total solid content of the composition.

(Solvent)

The composition may contain a solvent.

The solvent is preferably an organic solvent. Examples of the organic solvent include amides (for example, N,N-dimethylformamide); sulfoxides (for example, dimethylsulfoxide); heterocyclic compounds (for example, pyridine); hydrocarbons (for example, benzene and hexane); alkyl halides (for example, chloroform and dichloromethane); esters (for example, methyl acetate and butyl acetate); ketones (for example, acetone and methyl ethyl ketone); ethers (for example, tetrahydrofuran and 1,2-dimethoxyethane); and 1,4-butanediol diacetate.

In the case where the dichroic dye has liquid crystallinity, a suitable aspect of the composition may be, for example, a composition containing at least a dichroic dye and a chiral agent. In this case, it is preferred that the dichroic dye has a polymerizable group.

In the case where the dichroic dye does not have liquid crystallinity, a suitable aspect of the composition may be, for example, a composition containing at least a dichroic dye, a liquid crystal compound, and a chiral agent. In this case, it is preferred that the dichroic dye has a polymerizable group. Further, it is preferred that the liquid crystal compound has a polymerizable group.

(Procedure of Step 1)

A method of forming a coating film using the above composition is not particularly limited and may be, for example, a method of applying a composition.

Examples of the application method include a spin coating method, a dip coating method, a wire bar coating method, a direct gravure coating method, a reverse gravure coating method, and a die-coating method.

In addition, the composition can be appropriately applied onto a predetermined substrate. The substrate may be included in the reflective laminate, as will be described later.

After the coating film is formed, the coating film may be subjected to a drying treatment, if necessary. By carrying out the drying treatment, the solvent can be removed from the coating film.

Next, the coating film is subjected to a heating treatment to bring the dichroic dye into cholesteric alignment.

In the case where the dichroic dye itself has liquid crystallinity, the dichroic dye can be cholesterically aligned, for example, by subjecting a coating film formed using a composition containing a dichroic dye and a chiral agent to a heating treatment.

Further, in the case where the dichroic dye does not have liquid crystallinity, for example, there is a method in which a liquid crystal compound different from the dichroic dye is used in combination. That is, by subjecting a coating film formed using a composition containing a dichroic dye, a liquid crystal compound, and a chiral agent to a heating treatment, the dichroic dye can be cholesterically aligned together in the case where the liquid crystal compound is cholesterically aligned.

The method of heating the coating film is not particularly limited. For example, once the coating film is heated up to a temperature of the isotropic phase thereof, and then it is cooled down to a liquid crystalline phase transition temperature, whereby the coating film could be stably converted into a state of cholesteric alignment.

The phase transition temperature of the composition in the coating film is preferably 10° C. to 250° C. and more preferably 10° C. to 150° C. from the viewpoint of production suitability or the like.

As a preferable heating condition, it is preferable to heat the coating film at 50° C. to 120° C. (preferably 50° C. to 100° C.) for 1 to 5 minutes (preferably 1 to 3 minutes).

[Step 2]

Step 2 is a step of immobilizing the cholesteric alignment state formed in the coating film.

The method of immobilization is not particularly limited, but in the case where the dichroic dye and/or the liquid crystal compound used in combination with the dichroic dye has a polymerizable group, the coating film in the cholesteric alignment state is subjected to a curing treatment (for example, a light irradiation treatment or a heating treatment), whereby the alignment state thereof can be immobilized.

In addition, the method of immobilizing the cholesteric alignment state may be a method other than the above method (for example, a rapid cooling treatment).

The method of the curing treatment is not particularly limited, and examples thereof include a photo curing treatment and a thermal curing treatment. Among them, a light irradiation treatment is preferable, and an ultraviolet irradiation treatment is more preferable.

For ultraviolet irradiation, a light source such as an ultraviolet lamp is used.

The irradiation energy amount of ultraviolet rays is not particularly limited, but generally, it is preferably about 0.1 to 1.0 J/cm². The irradiation time of ultraviolet rays is not particularly limited and may be appropriately determined from the viewpoint of both hardness and productivity of the obtained reflective layer.

In order to accelerate the curing reaction, ultraviolet irradiation may be carried out under heating conditions.

In the foregoing step, the cholesteric alignment (cholesteric liquid crystalline phase) of the dichroic dye is fixed, whereby a reflective layer is formed. Here, as the state where the cholesteric alignment (cholesteric liquid crystalline phase) is “immobilized”, the most typical and preferred aspect is a state in which the alignment of the dichroic dye is retained. More specifically, it refers to a state in which, in a temperature range of usually 0° C. to 50° C. and in a temperature range of −30° C. to 70° C. under more severe conditions, this layer has no fluidity and can keep an immobilized alignment form stably without causing changes in alignment form due to external field or external force.

In the reflective layer, it is sufficient that the optical properties of the cholesteric alignment (cholesteric liquid crystalline phase) are retained in the layer, and finally the composition in the reflective layer no longer needs to show liquid crystallinity.

The first reflective layer and the second reflective layer in the reflective laminate can be respectively produced by the above-described methods.

The order of production of the first reflective layer and the second reflective layer is not particularly limited, and either may be produced first (in random order). In other words, the first reflective layer may be produced and then the second reflective layer may be produced on the first reflective layer, or the second reflective layer may be produced and then the first reflective layer may be produced on the second reflective layer.

Among them, from the viewpoint of easy production of a reflective laminate having excellent characteristics, preferred is a method for producing a reflective laminate, including a step X of bringing a composition containing a dichroic dye having a polymerizable group, a dextrorotatory chiral agent, and a polymerization initiator into a cholesteric alignment state, and then immobilizing the composition in the cholesteric alignment state to form a first reflective layer, and a step Y of bringing a composition containing a dichroic dye having a polymerizable group, a levorotatory chiral agent, and a polymerization initiator into a cholesteric alignment state, and then immobilizing the composition in the cholesteric alignment state to form a second reflective layer.

Either step X or step Y may be carried out first.

The content of the dichroic dye having a polymerizable group in the composition used in the step X and the step Y is not particularly limited, but from the viewpoint of superior effects of the present invention, it is preferably 45% by mass or more and more preferably 70% by mass or more with respect to the total solid content in the composition.

The solid content in the composition is preferably constituted only of the dichroic dye, the chiral agent, the polymerization initiator, and the alignment control agent.

[Other Members]

The reflective laminate may include members other than the first reflective layer and the second reflective layer described above. Hereinafter, optional members will be described in detail.

(Substrate)

For example, the reflective laminate may include a substrate that supports the first reflective layer and the second reflective layer. In other words, the reflective laminate may be a reflective laminate having a substrate, a first reflective layer, and a second reflective layer.

A known substrate can be used as the substrate, and examples thereof include a resin substrate and a glass substrate.

(Alignment Film)

Further, the reflective laminate may include an alignment film. The alignment film can be used in the production of the first reflective layer and/or the second reflective layer.

A known alignment film can be used as the alignment film. For example, the alignment film can be formed by applying a solution containing an alignment film forming material (for example, a polymer) onto a substrate, then heating and drying (crosslinking) the coating film, and subjecting the coating film to a rubbing treatment.

As the rubbing treatment, a treatment method widely adopted as a liquid crystal alignment treatment step of a liquid crystal display (LCD) can be applied.

(Ultraviolet Absorbing Layer)

In addition, the reflective laminate may include an ultraviolet absorbing layer. By disposing the ultraviolet absorbing layer on the outermost surface side of the reflective laminate on the light incident side, it is possible to suppress the photodegradation of the first reflective layer and the second reflective layer.

The ultraviolet absorbing layer preferably contains an ultraviolet absorber. The type of the ultraviolet absorber is not particularly limited, and a known ultraviolet absorber can be used. Examples of the ultraviolet absorber include a salicylic acid-based ultraviolet absorber, a benzophenone-based ultraviolet absorber, a benzotriazole-based ultraviolet absorber, a cyanoacrylate-based ultraviolet absorber, a benzoate-based ultraviolet absorber, a malonic acid ester-based ultraviolet absorber, and an oxalic acid anilide-based ultraviolet absorber.

In addition, the ultraviolet absorbing layer may contain a binder, if necessary.

It is preferred that the ultraviolet absorbing layer has absorption in the visible light range in that it imparts absorption characteristics in a wider range of wavelengths to the reflective laminate. More specifically, it is preferable to have absorption in the wavelength region of 200 to 500 nm.

The thickness of the ultraviolet absorbing layer is not particularly limited, but it is preferably 0.1 to 5 μm and more preferably 1 to 3 μm.

The ultraviolet absorbing layer may be formed as a separate layer from the above-mentioned member (for example, a substrate). Further, a substrate having an ultraviolet absorbing ability may be used as the ultraviolet absorbing layer by incorporating an ultraviolet absorber into the substrate.

(Light Absorbing Layer Absorbing at Least One of Visible Light or Near Infrared Light)

In addition, the reflective laminate may include a light absorbing layer (hereinafter, also simply referred to as “light absorbing layer”) that absorbs at least one of visible light or near infrared light. By disposing the light absorbing layer in the reflective laminate so as to absorb unnecessary wavelength regions in the transmitted light range excluding the reflection wavelength region and the absorption wavelength region formed of a dichroic dye, the reflective laminate can be used as a bandpass filter that transmits only necessary wavelengths.

In addition, the light absorbing layer is a layer that absorbs at least one (one or both) of visible light or near infrared light. The visible light may be, for example, light having a wavelength range of 400 to 700 nm. The near infrared light may be, for example, light having a wavelength range of greater than 700 nm and 2000 nm or less.

The type of the light absorbing material contained in the light absorbing layer is not particularly limited and known pigments and dyes may be mentioned. Above all, pigments are preferred.

The light absorbing layer may contain a binder. The type of binder is not particularly limited and a known binder may be used. Examples of the binder include a (meth)acrylic resin, a styrene resin, a urethane resin, an epoxy resin, a polyolefin resin, and a polycarbonate resin.

In addition, the binder contained in the light absorbing layer may be synthesized by including a polymerizable compound in the light absorbing layer forming composition used for forming the light absorbing layer and polymerizing the polymerizable compound. In addition, a pigment dispersant and an alkali-soluble resin may be contained as the binder.

The light absorbing layer may contain at least one of an ultraviolet light absorbing material or a near infrared light absorbing material. In the case where the light absorbing layer absorbs both ultraviolet light and near infrared light, it is preferred that both the ultraviolet light absorbing material and the near infrared light absorbing material are contained in the light absorbing layer.

A known material can be used as the ultraviolet light absorbing material.

Examples of the near infrared light absorbing material include a diketopyrrolopyrrole dye compound, a copper compound, a cyanine-based dye compound, a phthalocyanine-based compound, an immonium-based compound, a thiol complex-based compound, a transition metal oxide-based compound, a squarylium-based dye compound, a naphthalocyanine-based dye compound, a quaterrylene-based dye compound, a dithiol metal complex-based dye compound, and a croconium compound.

The maximum absorption wavelength of the near infrared light absorbing material is preferably in the range of 600 to 1000 nm. Among others, the maximum absorption wavelength of the near infrared light absorbing material is more preferably located on the shorter wavelength side than 850 nm or the shorter wavelength side than 940 nm which is used as a near infrared light emitting diode (LED) light source wavelength.

The film thickness of the light absorbing layer is not particularly limited, but it is preferably 0.1 to 3 μm and more preferably 0.5 to 1 μm.

The light absorbing layer may be formed as a separate layer from the above-mentioned member (for example, a substrate). A substrate that absorbs at least one of visible light or near infrared light may be used as the light absorbing layer by incorporating at least one of a visible light absorber or a near infrared light absorbing material into the substrate.

[Uses]

The reflective laminate can be applied to various uses, an example of which includes a bandpass filter. It should be noted that the bandpass filter refers to a filter set so as to pass only light in a specific wavelength range.

The bandpass filter including the reflective laminate is included in, for example, a wavelength selective sensor. In addition, the wavelength selective sensor may include a light receiving portion.

### Second Embodiment

FIG. 2 shows a cross-sectional view of a second embodiment of the reflective laminate of the present invention.

FIG. 2 is a cross-sectional view showing an example of a reflective laminate in the case of having two or more first reflective layers 12 and two or more second reflective layers 14. The reflective laminate 10b shown in FIG. 2 includes a first reflective layer 12a, a second reflective layer 14a, a first reflective layer 12b, and a second reflective layer 14b.

The reflective laminate 10a shown in FIG. 2 and the reflective laminate 10b shown in FIG. 1 have the same configuration except that the number of layers of the first reflective layer and the second reflective layer is different therebetween.

Both the first reflective layer 12a and the first reflective layer 12b are layers that reflect dextrorotatory circularly polarized light, and their selective reflection wavelengths are different from each other. More specifically, the selective reflection wavelength of the first reflective layer 12a is located on the longer wavelength side than the selective reflection wavelength of the first reflective layer 12b.

Both the second reflective layer 14a and the second reflective layer 14b are layers that reflect levorotatory circularly polarized light, and their selective reflection wavelengths are different from each other. More specifically, the selective reflection wavelength of the second reflective layer 14a is located on the longer wavelength side than the selective reflection wavelength of the second reflective layer 14b.

In addition, the first reflective layer 12a and the second reflective layer 14a have substantially the same helical pitch, and the selective reflection wavelengths of both are equal. In addition, the first reflective layer 12b and the second reflective layer 14b have substantially the same helical pitch, and the selective reflection wavelengths of both are equal.

In the case of such an aspect, the first reflective layer 12a and the second reflective layer 14a play a role of reflecting light on a longer wavelength side, and the first reflective layer 12b and the second reflective layer 14b play a role of reflecting light on a shorter wavelength side. In other words, by using the four reflective layers, the reflective laminate complementarily reflects light in a wide wavelength range.

The total number of layers of the first reflective layer and the total number of layers of the second reflective layer are independent of each other and may be the same or different, but preferably the same.

The reflective laminate may have two or more sets each including one layer of the first reflective layer and one layer of the second reflective layer. In this case, it is more preferred that the selective reflection wavelength of the first reflective layer and the selective reflection wavelength of the second reflective layer included in each set are equal to each other.

In the case where there are a plurality of first reflective layers included in the reflective laminate, it is preferred that the selective reflection wavelengths of the respective first reflective layers are different from each other. The reason for this is that the reflection efficiency does not become higher even in the case where there are a plurality of first reflective layers having the same selective reflection wavelength. Here, the selective reflection wavelengths of the two first reflective layers are different from each other is intended to mean that the difference between the two selective reflection wavelengths exceeds at least 20 nm. For example, in the case where there are a plurality of first reflective layers, the difference in selective reflection wavelength between the respective first reflective layers is preferably more than 20 nm, more preferably 30 nm or more, and still more preferably 40 nm or more.

Also, in the case where there are a plurality of second reflective layers included in the reflective laminate, it is likewise preferred that the selective reflection wavelengths of the respective second reflective layers are different from each other. In the case where there are a plurality of second reflective layers, the difference in selective reflection wavelength between the respective second reflective layers is preferably more than 20 nm, more preferably 30 nm or more, and still more preferably 40 nm or more.

In the case where the reflective laminate has two or more sets each including one layer of the first reflective layer and one layer of the second reflective layer, the selective reflection wavelengths of the first reflective layers included in different sets are preferably different from each other, and the selective reflection wavelengths of the second reflective layers included in different sets are preferably different from each other.

### Examples

Hereinafter, the features of the present invention will be described in more detail with reference to Examples and Comparative Examples. The materials, the used amount, the ratio, the contents of a treatment, and the procedures of a treatment described in Examples below may be suitably modified without departing from the spirit of the present invention. Accordingly, the scope of the present invention should not be limitatively interpreted by the specific examples described below.

<Synthesis of Polymerizable Dichroic Dye A>

Polymerizable dichroic dye A was synthesized according to the following scheme.

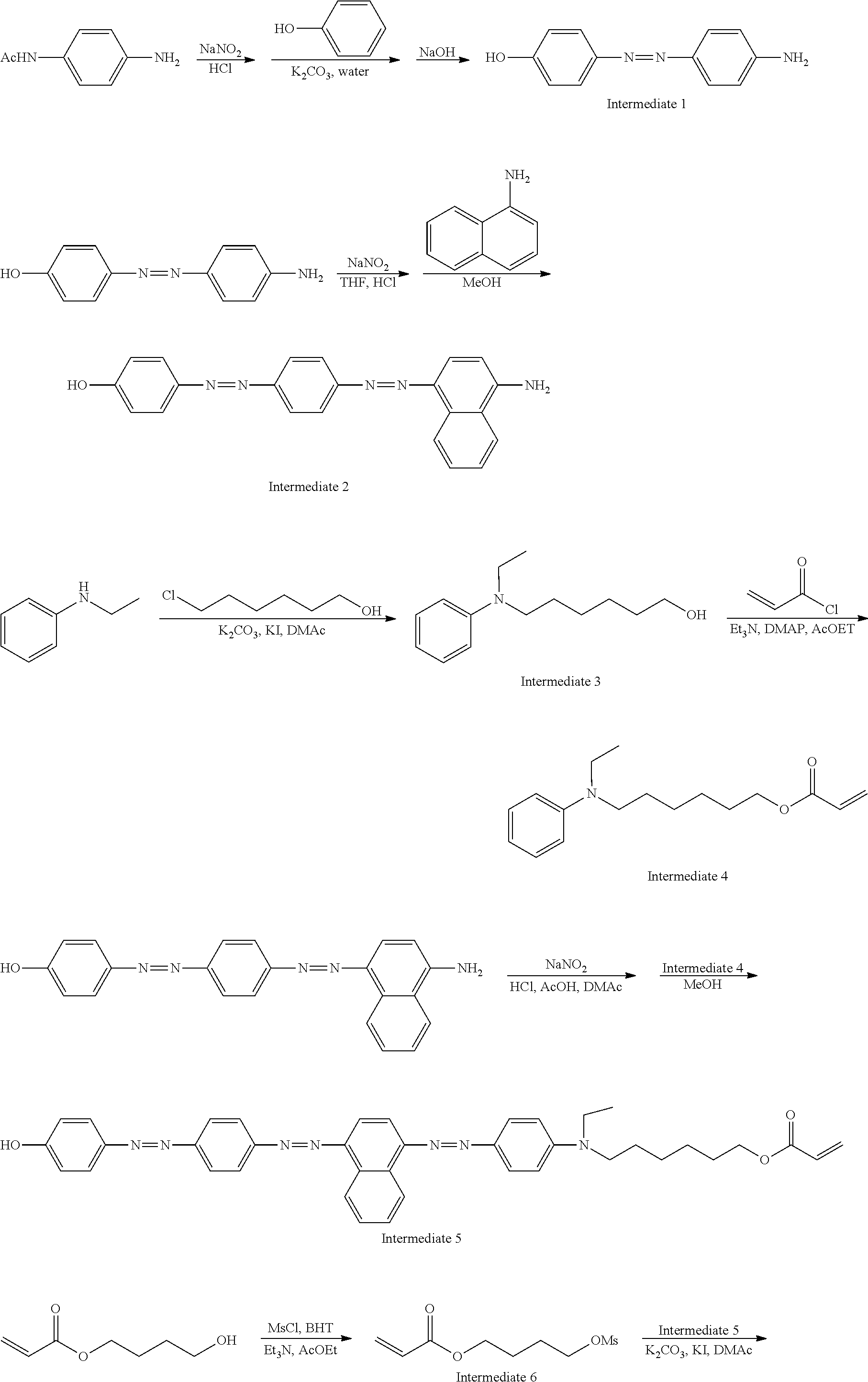

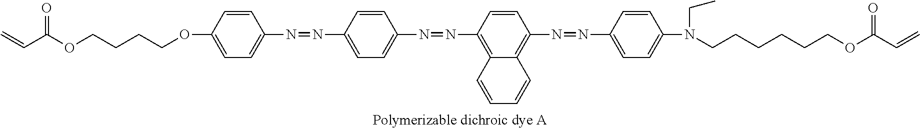 [SMILES: C=CC(=O)OCCCCCCN(CC)c1ccc(N=Nc2ccc(N=Nc3ccc(N=Nc4ccc(OCCCCOC(=O)C=C)cc4)cc3)c3ccccc23)cc1 ; "Polymerizable dichroic dye A"]

(Synthesis of Intermediate 1)

While stirring Solution A of 4-amino-N-acetylaniline (27.0 g) dissolved in 0.9 N aqueous hydrochloric acid (865 mL) at 5° C. or lower, Solution B of sodium nitrite (13.5 g) dissolved in water (40 mL) was added portionwise to Solution A. Solution B was added to Solution A while maintaining the temperature of the mixed solution of Solution A and Solution B at 5° C. or lower. The resulting reaction solution was maintained at a temperature of 5° C. or lower and stirred for about 1 hour. Then, after confirming the formation of a diazonium salt in the reaction solution, the reaction solution was added dropwise portionwise to Solution C of phenol (17.4 g) and potassium carbonate (138 g) dissolved in water (500 mL) and ice-cooled to 0° C. The reaction solution was added dropwise to Solution C while maintaining the temperature of the mixed solution of Solution C and the reaction solution at 5° C. or lower. After completion of the dropwise addition, the resulting reaction solution was heated to room temperature and neutralized with hydrochloric acid. The precipitated product was recovered by filtration and the resulting product was added to 2 N aqueous sodium hydroxide (500 mL), and the resulting reaction solution was heated and stirred at 120° C. to carry out deacetylation. The reaction solution was cooled to room temperature and then neutralized with hydrochloric acid, and the precipitated solid was recovered by filtration. The resulting solid was washed with water and then dried to give Intermediate 1 (34.2 g) (yield: 89%).

(Synthesis of Intermediate 2)

While stirring Solution D of Intermediate 1 (10.0 g) dissolved in 2 N aqueous hydrochloric acid (100 mL) and tetrahydrofuran (THF) (100 mL) at 5° C. or lower, Solution E of sodium nitrite (3.56 g) dissolved in water (20 mL) was added portionwise to Solution D. Solution E was added to Solution D while maintaining the temperature of the mixed solution of Solution D and Solution E at 5° C. or lower. The resulting reaction solution was maintained at a temperature of 5° C. or lower and stirred for about 1 hour. Then, after confirming the formation of a diazonium salt in the reaction solution, the reaction solution was added dropwise portionwise to Solution F of 1-aminonaphthalene (7.39 g) dissolved in methanol (80 mL) and ice-cooled to 0° C. The reaction solution was added dropwise to Solution F while maintaining the temperature of the mixed solution of Solution F and the reaction solution at 5° C. or lower. After completion of the dropwise addition, the resulting reaction solution was heated to room temperature and neutralized with a saturated aqueous solution of sodium hydrogencarbonate. The precipitated product was recovered by filtration. The resulting solid was washed with water and then dried to give Intermediate 2 (16.9 g) (yield: 98%).

(Synthesis of Intermediate 3)

N-ethylaniline (24.2 g), 6-chlorohexanol (27.4 g), potassium carbonate (30.4 g), and potassium iodide (3.4 g) were added to N,N-dimethylacetamide (100 mL), and the resulting reaction solution was stirred at 100° C. for 2 hours. The reaction solution was cooled to room temperature and partitioned in an aqueous ammonium chloride solution and ethyl acetate, and the organic layer was recovered. After that, the organic layer was dried over magnesium sulfate. The magnesium sulfate was removed from the organic layer by filtration and then the filtrate was concentrated. The resulting solid was purified by column chromatography to give Intermediate 3 (38.5 g) (yield: 87%).

(Synthesis of Intermediate 4)

While stirring Solution G of Intermediate 3 (38.5 g), triethylamine (21.1 g), and dimethylaminopyridine (2.1 g) dissolved in ethyl acetate (100 mL) at 0° C. or lower, acrylic acid chloride (18.9 g) was added dropwise portionwise to Solution G. Acrylic acid chloride was added to Solution G while maintaining the temperature of the mixed solution of acrylic acid chloride and Solution G at 5° C. or lower. The resulting mixed solution was stirred at room temperature for 1 hour and then partitioned in an aqueous ammonium chloride solution and ethyl acetate, and the organic layer was recovered. After that, the organic layer was dried over magnesium sulfate. The magnesium sulfate was removed from the organic layer by filtration and then the filtrate was concentrated. The resulting solid was purified by column chromatography to give Intermediate 4 (14.6 g) (yield: 31%).

(Synthesis of Intermediate 5)

While stirring Solution H of Intermediate 2 (3.0 g) dissolved in 12 N aqueous hydrochloric acid (2.7 mL), acetic acid (7.5 mL), and N,N-dimethylacetamide (60 mL) at 5° C. or lower, Solution I of sodium nitrite (0.62 g) dissolved in water (1 mL) was added portionwise to Solution H. Solution I was added to Solution H while maintaining the temperature of the mixed solution of Solution H and Solution I at 5° C. or lower. The resulting reaction solution was maintained at a temperature of 5° C. or lower and stirred for about 1 hour. After confirming the formation of a diazonium salt in the reaction solution, the reaction solution was added dropwise portionwise into Solution J of Intermediate 4 (2.47 g) dissolved in 30 mL of methanol and ice-cooled to 0° C. The reaction solution was added dropwise to Solution J while maintaining the temperature of the mixed solution of Solution J and the reaction solution at 5° C. or lower. After completion of the dropwise addition, the resulting reaction solution was heated to room temperature and neutralized with a saturated aqueous solution of sodium hydrogencarbonate. The precipitated product was filtered and then purified by column chromatography to give Intermediate 5 (1.50 g) (yield: 28%).

(Synthesis of Intermediate 6)

While stirring Solution K of 4-hydroxybutyl acrylate (10.0 g), triethylamine (8.2 g), and dibutylhydroxytoluene (0.31 g) dissolved in ethyl acetate (50 mL) at 0° C. or lower, methanesulfonic acid chloride (8.4 g) was added dropwise portionwise to Solution K. Methanesulfonic acid chloride was added to Solution K while maintaining the temperature of the mixed solution of methanesulfonic acid chloride and Solution K at 5° C. or lower. After stirring the resulting reaction solution at room temperature for 1 hour, 50 mL of water was added to the reaction solution, and the organic layer was recovered by a liquid separation treatment. Next, the resulting organic layer was dried over magnesium sulfate. After removing magnesium sulfate from the organic layer by filtration, the organic layer was concentrated to give Intermediate 6 (15.3 g) (yield: 99%).

(Synthesis of Polymerizable Dichroic Dye A)

Intermediate 5 (1.0 g), Intermediate 6 (0.34 g), potassium carbonate (0.21 g), and potassium iodide (0.023 g) were stirred in N,N-dimethylacetamide (10 mL) at 80° C. for 2 hours. The reaction solution was cooled to room temperature and methanol was added thereto, and the precipitated product was recovered by filtration. The recovered product was purified by column chromatography to give polymerizable dichroic dye A (0.92 g) (yield: 78%).

The details of ¹H-NMR (Nuclear Magnetic Resonance) (CDCl₃) are 9.05 (m, 2H), 8.20 (d, 2H), 8.02 (m, 8H), 7.72 (m, 2H), 7.03 (d, 1H), 6.78 (d, 2H), 6.40 (m, 2H), 6.15 (m, 2H), 5.82 (m, 2H), 4.28 (t, 2H), 4.19 (t, 2H), 4.11 (t, 2H), 3.50 (t, 2H), 3.40 (t, 2H), 1.94 (m, 4H), 1.71 (m, 4H), 1.45 (m, 4H), 1.25 (t, 3H).

The polymerizable dichroic dye A had liquid crystallinity and was confirmed to be a nematic liquid crystal having an isotropic phase transition temperature of 118° C. In addition, the polymerizable dichroic dye A was confirmed to be a dichroic dye by observation under a polarizing microscope.

In addition, the absorption maximum wavelength of the polymerizable dichroic dye A was 542 nm. Further, Δn at a wavelength of 800 nm at a temperature of 35° C. was 1.18.

<Preparation of Coating Liquid (R1)>

A polymerizable liquid crystal 1, a polymerizable dichroic dye A, a fluorine-based horizontal alignment agent 1, a chiral agent, a polymerization initiator, and a solvent were mixed to prepare a coating liquid (R1) having the following composition.

| Polymerizable liquid crystal 1 | 50 | parts by mass |
|---|---|---|
| Polymerizable dichroic dye A | 50 | parts by mass |
| Fluorine-based horizontal alignment | 0.1 | parts by mass |
| agent 1 | | |
| Dextrorotatory chiral agent LC756 | 1.5 | parts by mass |
| (manufactured by BASF Corporation) | | |
| Polymerization initiator IRGACURE 819 | 4 | parts by mass |

| | |
|---|---|
| (manufactured by Ciba Japan K.K.) | |
| Solvent (chloroform) | amount to make a solute |
| | concentration of 15% by mass |

<Preparation of Coating Liquid (R2)>

A polymerizable liquid crystal 1, a polymerizable dichroic dye A, a fluorine-based horizontal alignment agent 1, a chiral agent, a polymerization initiator, and a solvent were mixed to prepare a coating liquid (R2) having the following composition.

| Polymerizable liquid crystal 1 | 40 | parts by mass |
|---|---|---|
| Polymerizable dichroic dye A | 60 | parts by mass |
| Fluorine-based horizontal alignment | 0.1 | parts by mass |
| agent 1 | | |
| Dextrorotatory chiral agent LC 756 | 1.65 | parts by mass |
| (manufactured by BASF Corporation) | | |
| Polymerization initiator | 4 | parts by mass |

| | |
|---|---|
| (IRGACURE 819 (manufactured by Ciba | |
| Japan K.K.)) | |
| Solvent (chloroform) | amount to make a solute |
| | concentration of 15% by mass |

<Preparation of Coating Liquid (L1)>

A polymerizable liquid crystal 1, a polymerizable dichroic dye A, a fluorine-based horizontal alignment agent 1, a chiral agent, a polymerization initiator, and a solvent were mixed to prepare a coating liquid (L1) having the following composition.

| | |
|---|---|
| Polymerizable liquid crystal 1 | 50 parts by mass |
| Polymerizable dichroic dye A | 50 parts by mass |
| Fluorine-based horizontal alignment agent 1 | 0.1 parts by mass |
| Levorotatory chiral agent 1 | 5 parts by mass |
| Polymerization initiator IRGACURE 819 | 4 parts by mass |
| (manufactured by Ciba Japan K.K.) | |
| Solvent (chloroform) | amount to make a solute concentration of 15% by mass |

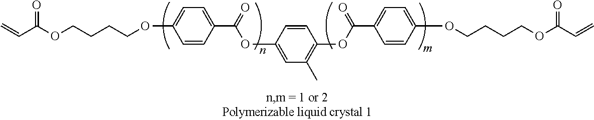

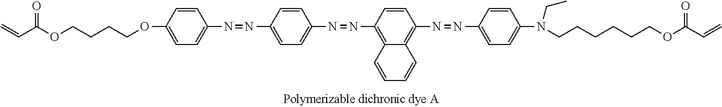 [SMILES: C=CC(=O)OCCCCCCN(CC)c1ccc(N=Nc2ccc(N=Nc3ccc(N=Nc4ccc(OCCCCOC(=O)C=C)cc4)cc3)c3ccccc23)cc1]

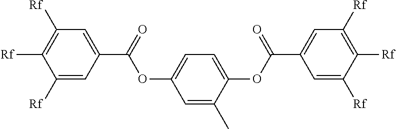

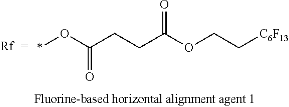

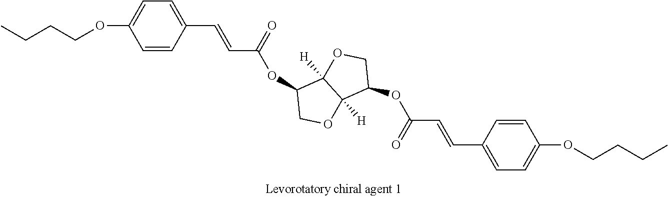 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

The maximum absorption wavelength of the polymerizable liquid crystal 1 was 266 nm.

<Formation of Reflective Layer>

The surface of an alignment film in a glass substrate with an alignment film (SE-130, manufactured by Nissan Chemical Industries, Ltd.) was subjected to a rubbing treatment. Next, using the coating liquid (R1) prepared above, a reflective layer having a selective reflection wavelength at about 1000 nm was produced on the surface of the alignment film by the following procedure.

(1) On an alignment film in a glass substrate with an alignment film (SE-130, manufactured by Nissan Chemical Industries, Ltd.), a coating liquid (R1) was applied by a spin coater at room temperature so that the thickness of the film after drying was 2.5 μm.

(2) After the coating film was dried at room temperature for 30 seconds to remove the solvent, the coating film was heated in an atmosphere at 100° C. for 1 minute to bring the dichroic dye into cholesteric alignment, whereby a cholesteric liquid crystalline phase was formed. Next, the coating film was subjected to UV (ultraviolet light) irradiation (28.6 mW/cm², 35 seconds) at 80° C. in a nitrogen atmosphere using HOYA-SCHOTT EXECURE-3000W (manufactured by HOYA CANDEO OPTRONICS Corporation), and a cholesteric liquid crystalline phase was fixed to produce a reflective layer (FR1) which is obtained by fixing the dichroic dye in the cholesteric alignment state on the glass substrate.

In addition, reflective layers (FR2) and (FL1) were produced in the same manner as the method of producing the reflective layer (FR1), except that coating liquids (R2) and (L1) were used in place of the coating liquid (R1).

<Production of Reflective Laminate>
(1) The coating liquid (L1) was applied onto the reflective layer (FR1) by a spin coater at room temperature so that the thickness of the film after drying was 2.5 μm.

(2) After the coating film was dried at room temperature for 30 seconds to remove the solvent, the coating film was heated in an atmosphere at 100° C. for 1 minute to bring the dichroic dye into cholesteric alignment, whereby a cholesteric liquid crystalline phase was formed. Next, the coating film was subjected to UV irradiation (28.6 mW/cm², 35 seconds) at 80° C. in a nitrogen atmosphere using HOYA-SCHOTT EXECURE-3000W (manufactured by HOYA CANDEO OPTRONICS Corporation), and a cholesteric liquid crystalline phase was fixed to produce a reflective laminate (F1).

<Preparation of Coating Liquid (CR1)>

A polymerizable liquid crystal 1, a fluorine-based horizontal alignment agent 1, a chiral agent, a polymerization initiator, and a solvent were mixed to prepare a coating liquid (CR1) having the following composition.

| Polymerizable liquid crystal 1 | 100 | parts by mass |
|---|---|---|
| Fluorine-based horizontal alignment | 0.1 | parts by mass |
| agent 1 | | |
| Dextrorotatory chiral agent LC756 | 1.65 | parts by mass |
| (manufactured by BASF Corporation) | | |
| Polymerization initiator IRGACURE 819 | 4 | parts by mass |

| | |
|---|---|
| (manufactured by Ciba Japan K.K.) | |
| Solvent (chloroform) | amount to make a solute |
| | concentration of 15% by mass |

<Preparation of Coating Liquid (CL1)>

A polymerizable liquid crystal 1, a fluorine-based horizontal alignment agent 1, a chiral agent, a polymerization initiator, and a solvent were mixed to prepare a coating liquid (CL1) having the following composition.

| | | |
|---|---|---|
| Polymerizable liquid crystal 1 | 100 | parts by mass |
| Fluorine-based horizontal alignment | 0.1 | parts by mass |
| agent 1 | | |
| Levorotatory chiral agent 1 | 5.5 | parts by mass |
| Polymerization initiator IRGACURE 819 | 4 | parts by mass |

| | |
|---|---|
| (manufactured by Ciba Japan K.K.) | |
| Solvent (chloroform) | amount to make a solute |
| | concentration of 15% by mass |

<Formation of Reflective Layer>

Reflective layers (CFR1) and (CFL1) were produced in the same manner as the method of producing the reflective layer (FR1), except that coating liquids (CR1) and (CL1) were used in place of the coating liquid (R1).

<Evaluation of Reflective Layer and Reflective Laminate>

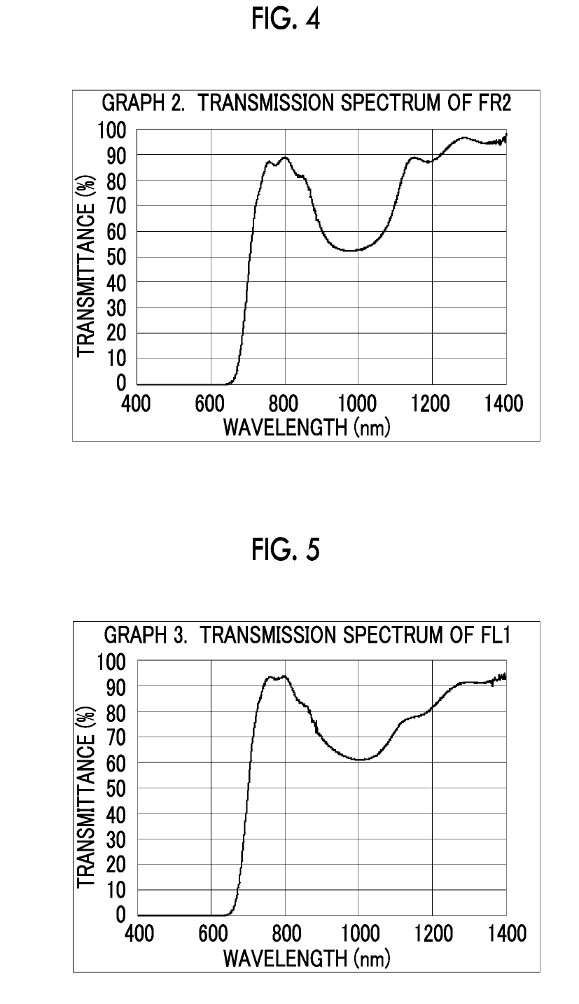

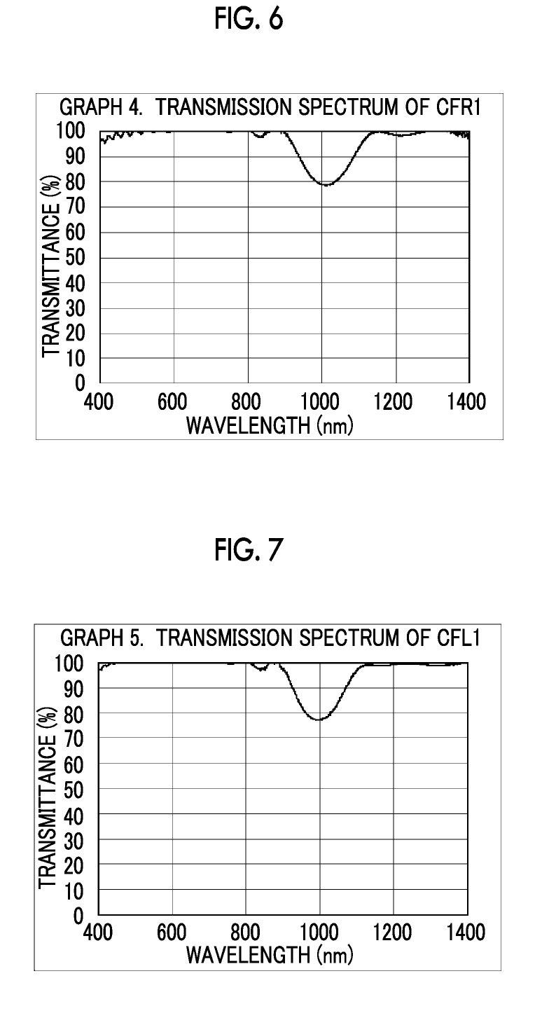

Transmission spectra of reflective layers (FR1), (FR2), (FL1), (CFR1), and (CFL1) and reflective laminate (F1) were measured with a UV-Vis-NIR spectrophotometer UV-3100PC (manufactured by Shimadzu Corporation). The results are shown in FIGS. 3 to 8, respectively. The measurement was carried out by a baseline treatment with a glass substrate with an alignment film.

The selective reflection wavelength of the reflective layer (FR1) was 1040 nm, the selective reflection wavelength of the reflective layer (FR2) was 990 nm, the selective reflection wavelength of the reflective layer (FL1) was 1000 nm, the selective reflection wavelength of the reflective layer (CFR1) was 1020 nm, and the selective reflection wavelength of the reflective layer (CFL1) was 1000 nm.

As is apparent from FIGS. 3 to 7, the reflective layers (FR1), (FR2), and (FL1) can efficiently reflect light in a wide wavelength range, in contrast to the reflective layers (CFR1) and (CFL1) corresponding to Comparative Examples not using a dichroic dye. A reflective laminate including such a reflective layer can also efficiently reflect light in a wide wavelength range.

Further, it can be seen that the reflective layers (FR1), (FR2), and (FL1) have light-shielding properties due to absorption of the dye in the wavelength range of 700 nm or less.

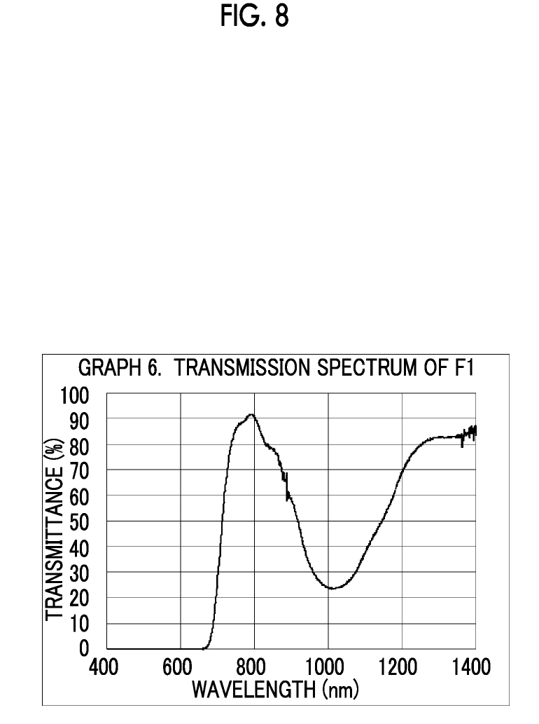

Further, as is apparent from FIG. 8, it can be seen that the reflective laminate (F1) having a wide reflection band in the near infrared light range can be obtained by the lamination of the reflective layer (FR1) having reflection characteristics for dextrorotatory circularly polarized light and the reflective layer (FL1) having reflection characteristics for levorotatory circularly polarized light.

### EXPLANATION OF REFERENCES

10a, 10b: reflective laminate
12, 12a, 12b: first reflective layer
14, 14a, 14b: second reflective layer

What is claimed is:

1. A reflective laminate comprising:
at least one first reflective layer that reflects dextrorotatory circularly polarized light; and
at least one second reflective layer that reflects levorotatory circularly polarized light,
wherein the selective reflection wavelengths of the first reflective layer and the second reflective layer are each 600 nm or more, and
each of the first reflective layer and the second reflective layer is a layer obtained by immobilizing a dichroic dye having an absorption maximum wavelength on a longer wavelength side than 400 nm in a cholesteric alignment state.

2. The reflective laminate according to claim 1, wherein the content of the dichroic dye in at least one of the first reflective layer or the second reflective layer is 45% by mass or more with respect to the total mass of the layer.

3. The reflective laminate according to claim 1, wherein the dichroic dye has liquid crystallinity.

4. The reflective laminate according to claim 1, wherein a total value of a film thickness of the first reflective layer and a film thickness of the second reflective layer is 10 μm or less.

5. The reflective laminate according to claim 1, further comprising:
an ultraviolet absorbing layer.

6. The reflective laminate according to claim 5, wherein the ultraviolet absorbing layer has absorption in a visible light range.

7. The reflective laminate according to claim 1, further comprising:
a light absorbing layer that absorbs at least one of visible light or near infrared light.

8. A bandpass filter comprising:
the reflective laminate according to claim 1.

9. A wavelength selective sensor comprising:
the bandpass filter according to claim 8.

10. A method for producing the reflective laminate according to claim 1, comprising:
a step of bringing a composition containing a dichroic dye having a polymerizable group, a dextrorotatory chiral agent, and a polymerization initiator into a cholesteric alignment state and then immobilizing the composition in the cholesteric alignment state to form a first reflective layer; and
a step of bringing a composition containing a dichroic dye having a polymerizable group, a levorotatory chiral agent, and a polymerization initiator into a cholesteric alignment state and then immobilizing the composition in the cholesteric alignment state to form a second reflective layer.

11. The method for producing the reflective laminate according to claim 10, wherein the content of the dichroic dye having a polymerizable group is 45% by mass or more with respect to the total solid content in the composition.

12. The method for producing the reflective laminate according to claim 10, wherein the composition includes a liquid crystal compound which has a polymerizable group and has no absorption maximum wavelength on a longer wavelength side than 400 nm.

13. The reflective laminate according to claim 2, wherein the dichroic dye has liquid crystallinity.

14. The reflective laminate according to claim 2, wherein a total value of a film thickness of the first reflective layer and a film thickness of the second reflective layer is 10 μm or less.

15. The reflective laminate according to claim 3, wherein a total value of a film thickness of the first reflective layer and a film thickness of the second reflective layer is 10 μm or less.

16. The reflective laminate according to claim 2, further comprising:
an ultraviolet absorbing layer.

17. The reflective laminate according to claim 3, further comprising:
an ultraviolet absorbing layer.

18. The reflective laminate according to claim 4, further comprising:
an ultraviolet absorbing layer.

19. The reflective laminate according to claim 2, further comprising:
a light absorbing layer that absorbs at least one of visible light or near infrared light.

20. The reflective laminate according to claim 3, further comprising:
a light absorbing layer that absorbs at least one of visible light or near infrared light.
